(19) United States
(12) Patent Application Publication
(10) Pub. No.: US 2012/0276382 A1
(43) Pub. Date: Nov. 1, 2012

(54) ADHESIVE COMPOSITE SYSTEM FOR COVERING, CLOSING OR GLUING CELLULAR TISSUE

(75) Inventors: Sebastian Dörr, Dusseldorf (DE); Heike Heckroth, Odenthal (DE); Christoph Eggert, Koln (DE)

(73) Assignee: Bayer Intellectual Property GmbH, Monheim (DE)

(21) Appl. No.: 13/515,100

(22) PCT Filed: Dec. 6, 2010
(86) PCT No.: PCT/EP2010/068985

§ 371 Date: Jun. 11, 2012

(30) Foreign Application Priority Data
Dec. 12, 2009 (EP) 09015401.4

(51) Int. Cl. B32B 27/40; C09J 7/02; B32B 27/08; B32B 37/12

(52) U.S. Cl. 428/355 N; 156/331.7; 428/423.1

(57) ABSTRACT

The invention relates to an adhesive composite system comprising an adhesive layer of a tissue adhesive and a protective layer which is applied to the surface of the adhesive layer, said tissue adhesive being based on hydrophilic polyurethane polymers and the protective layer is water-proof. The invention also relates to a method for producing said adhesive composite system, to an adhesive composite system obtained according to said method, an adhesive composite system which can be used for covering, closing or gluing cellular tissue and to the use of the adhesive composite system for producing a product for covering, closing or gluing cellular tissue.

The present invention relates to a composite adhesive system. Further subject matter of the invention includes a method for producing the composite adhesive system, a composite adhesive system obtainable by the method, a composite adhesive system for use as a means for covering, sealing or bonding cell tissue, and the use of the composite adhesive system for producing a means for covering, sealing or bonding cell tissue.

EP 2 011 808 A1 discloses tissue adhesives based on a hydrophilic 2-component polyurethane system. These tissue adhesives can be used for covering, sealing or bonding cell tissue and more particularly for bonding wounds. The tissue adhesives described are notable for strong binding to the tissue, for high flexibility of the resultant join, for ease of application, for a curing time which can be adjusted within a wide range, and for high biocompatibility.

The use of the known tissue adhesives is also, however, accompanied by certain problems. For instance, owing to the hydrophilicity of the polyurethane systems, prolonged exposure with water may be accompanied by swelling of the tissue adhesive. This reduces the adhesion of the tissue adhesive to the tissue, and this may overall have adverse consequences for the durability of the bond.

It was an object of the present invention, therefore, to provide a composite adhesive system which can be used for producing an easy-to-apply, biocompatible, elastic bond which adheres strongly to tissue, which does not swell even on prolonged exposure to water, and is therefore lastingly durable even under these conditions.

This object is achieved by means of a composite adhesive system comprising an adhesive layer composed of a tissue adhesive, and a protective layer applied extensively over the adhesive layer, in which the tissue adhesive is based on hydrophilic polyurethane polymers, and the protective layer is water-impermeable.

“Water-impermeable” in the sense of the present invention is applied to a protective layer which protects an underlying adhesive layer from swelling for a time of at least 30 minutes when the composite adhesive system composed of adhesive layer and protective layer is immersed into a water bath with a temperature of up to 40° C.

The water-impermeable layer is preferably distinguished by the feature that, when a layer of this kind is stored as a free film with a thickness of 100 micrometers in an excess of demineralized water at 23° C. for a period of 2 hours, the mass of water absorbed, based on the initial mass of the film, is below 100%, preferably below 50%, more preferably below 20% and very preferably below 10%.

The tissue adhesive comprises
A) isocyanate-functional prepolymers obtainable from
   A1) aliphatic isocyanates and
   A2) polyols having number-average molecular weights of ≧400 g/mol and average OH functionalities of 2 to 6,
B) amino-functional aspartic esters of the general formula (I)

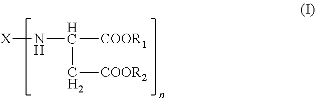

in which
X is an n-valent organic radical obtained by removing a primary amino group of an n-valent amine,
R₁ and R₂ are identical or different organic radicals which contain no Zerewitinoff-active hydrogen, and
n is an integer of at least 2,
and/or
C) reaction products of isocyanate-functional prepolymers A) with aspartic esters B).

The tissue adhesive stated above is notable for strong bonding to the tissue, for high flexibility of the resultant join, for ease of application, for a curing time which can be adjusted within a wide range, and for high biocompatibility.

For the definition of Zerewitinoff-active hydrogen, reference is made to the corresponding entry on “active hydrogen” in Römpp Chemie Lexikon, Georg Thieme Verlag, Stuttgart. Groups with Zerewitinoff-active hydrogen are understood preferably to be OH, NH or SH.

As isocyanates A1) it is possible, for example, to use monomeric aliphatic or cycloaliphatic di- or triisocyanates such as butylene 1,4-diisocyanate (BDI), hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, cyclohexylene 1,4-diisocyanate, 4-isocyanatomethyloctane 1,8-diisocyanate (nonane triisocyanate), and also alkyl 2,6-diisocyanatohexanoate (lysine diisocyanate) with C1-C8 alkyl groups.

In one particularly preferred embodiment, hexamethylene diisocyanate exclusively is used.

Besides the abovementioned monomeric isocyanates it is also possible to use their derivatives of higher molecular mass, having uretdione, isocyanurate, urethane, allophanate, biuret, iminooxadiazinedione or oxadiazinetrione structure, and also mixtures thereof.

The isocyanates A1) may preferably contain exclusively aliphatically or cycloaliphatically bonded isocyanate groups.

The isocyanates or isocyanate mixtures A1) preferably have an average NCO functionality of 2 to 4, more preferably 2 to 2.6 and very preferably 2 to 2.4.

As polyols A2) it is possible in principle to use all polyhydroxy compounds, having 2 or more OH functions per molecule, that are known per se to the skilled person. These may be, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, polyester polycarbonate polyols or any desired mixtures thereof.

The polyols A2) preferably have an average OH functionality of 3 to 4.

The polyols A2) further preferably have a number-average molecular weight of 400 to 20 000 g/mol, more preferably of 2000 to 10 000 g/mol and very preferably of 4000 to 8500.

Particularly preferred polyether polyols are polyalkylene oxide polyethers based on ethylene oxide and optionally propylene oxide.

These polyether polyols are based preferably on starter molecules with a functionality of two or more, such as amines or alcohols with a functionality of two or more.

Examples of such starters are water (interpreted as a diol), ethylene glycol, propylene glycol, butylene glycol, glycerol, TMP, sorbitol, pentaerythritol, triethanolamine, ammonia or ethylenediamine.

It is also preferred if the polyols A2) are polyalkylene oxide polyethers having more particularly an ethylene oxide-based units content of 60% to 90% by weight, based on the amounts of alkylene oxide units present overall.

Preferred polyester polyols are polycondensates of di- and also optionally tri- and tetraols and di- and also optionally tri- and tetracarboxylic acids or hydroxycarboxylic acids or lactones. In place of the free polycarboxylic acids, it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, and also 1,2-propanediol, 1,3-propanediol, butane-1,3-diol, butane-1,4-diol, hexane-1,6-diol and isomers, neopentylglycol or neopentylglycol hydroxypivalate, with preference being given to hexane-1,6-diol and isomers, butane-1,4-diol, neopentylglycol and neopentylglycol hydroxypivalate. In addition it is also possible to use polyols such as trimethylolpropane, glycerol, erythritol, pentaerythritol, trimethylolbenzene or trishydroxyethyl isocyanurate.

As dicarboxylic acids it is possible to use phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid. The corresponding anhydrides may also be used as a source of acid.

Where the average functionality of the polyol to be esterified is >than 2, it is additionally also possible to use monocarboxylic acids as well, such as benzoic acid and hexanecarboxylic acid.

Preferred acids are aliphatic or aromatic acids of the aforementioned kind. Particularly preferred are adipic acid, isophthalic acid and phthalic acid.

Hydroxycarboxylic acids, which may be used as well as reaction participants in the preparation of a polyester polyol having terminal hydroxyl groups, are, for example, hydroxycaproic acid, hydroxybutyric acid, hydroxydecanoic acid, hydroxystearic acid and the like. Suitable lactones are caprolactone, butyrolactone and homologs. Caprolactone is preferred.

It is likewise possible to use polycarbonates containing hydroxyl groups, preferably polycarbonate diols, having number-average molecular weights Mn of 400 to 8000 g/mol, preferably 600 to 3000 g/mol. They are obtainable by reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentylglycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A and lactone-modified diols of the aforementioned kind.

For preparing the prepolymer A) it is possible for isocyanates A1) to be reacted with polyols A2) with an NCO/OH ratio of preferably 4:1 to 12:1, more preferably of 8:1. Subsequently the fraction of unreacted isocyanates A1) can be separated off by means of suitable techniques. For this purpose it is usual to use thin-film distillation, giving products of low residual monomer content, having residual monomer contents of less than 1% by weight, preferably less than 0.5% by weight, very preferably less than 0.1% by weight.

Optionally it is possible during the preparation to add stabilizers such as benzoyl chloride, isophthaloyl chloride, dibutyl phosphate, 3-chloropropionic acid or methyl tosylate.

The reaction temperature here is more particularly 20 to 120° C., preferably 60 to 100° C.

Preferred amino-functional aspartic esters are those in which in the formula (I):
R1 and R2 are identical or different, optionally branched or cyclic, organic radicals which contain no Zerewitinoff-active hydrogen, having 1 to 20, preferably 1 to 10, carbon atoms, more preferably methyl or ethyl groups,
n is an integer from 2 to 4, and
X is an n-valent organic, optionally branched or cyclic, organic radical having 2 to 20, preferably 5 to 10, carbon atoms, which is obtained by removing a primary amino group of an n-valent primary amine.

It is of course also possible to use mixtures of two or more aspartic esters, and so n in the formula (I) may also denote a non-integral average value.

The amino-functional polyaspartic esters B1) can be prepared in a known way by reaction of the corresponding primary at least difunctional amines X(NH₂)ₙ with maleic or fumaric esters of the general formula (II)

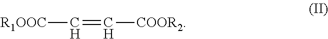

Preferred maleic or fumaric esters are dimethyl maleate, diethyl maleate, dibutyl maleate and the corresponding fumaric esters.

Preferred primary at least difunctional amines X(NH₂)ₙ are ethylenediamine, 1,2-diaminopropane, 1,4-diaminobutane, 1,3-diaminopentane, 1,5-diaminopentane, 2-methyl-1,5-diaminopentane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′- and/or 4,4′-diaminodicyclohexylmethane, 3,3′-dimethyl-4,4′-diaminodicyclohexylmethane, 2,4,4′-triamino-5-methyldicyclohexylmethane and polyetheramines having aliphatically bonded primary amino groups with a number-average molecular weight Mn of 148 to 6000 g/mol.

Particularly preferred primary at least difunctional amines are 1,3-diaminopentane, 1,5-diaminopentane, 2-methyl-1,5-diaminopentane, 1,6-diaminohexane, 1,13-diamino-4,7,10-trioxamidecane. Especially preferred is 2-methyl-1,5-diaminopentane.

In one preferred embodiment R1=R2=ethyl, with X being based on 2-methyl-1,5-diaminopentane as n-valent amine.

The amino-functional aspartic esters B1) are prepared from the stated starting materials in accordance for example with DE-A 69 311 633, preferably within the temperature range from 0 to 100° C., the starting materials being used in proportions such that there is at least one, preferably precisely one, olefinic double bond to each primary amino group, and after the reaction any starting materials used in excess can be removed by distillation. The reaction may take place in bulk or in the presence of suitable solvents such as methanol, ethanol, propanol or dioxane, or mixtures of such solvents.

In order to reduce further the average equivalent weight of the compounds used in total for prepolymer crosslinking, based on the NCO-reactive groups, it is possible, in addition to the compounds used in B1), to prepare the amino- or hydroxy-functional reaction products of isocyanate-functional prepolymers with aspartic esters as well in a separate, preliminary reaction, and then to use them as relatively higher molecular weight curing component C).

For the preliminary lengthening (advancement) it is preferred to use ratios of isocyanate-reactive groups to isocyanate groups of 50:1 to 1.5:1, more preferably of 15:1 to 4:1.

The isocyanate-functional prepolymer to be used for this purpose may correspond to that of component A) or else may be synthesized differently from the components as listed as possible constituents of the isocyanate-functional prepolymers in the context of this specification.

The 2-component adhesive systems of the invention are obtained by mixing the prepolymer with the curing component B) and/or C). The ratio of NCO-reactive NH groups to free NCO groups is preferably 1:1.5 to 1:1, more preferably 1:1.

A development of the invention envisages the tissue adhesive as comprising no aspartic esters B) but instead exclusively reaction products C).

The adhesive layer may also, in addition, comprise one or more active ingredients. The active ingredients may more particularly be substances which assist wound healing.

According to one further preferred embodiment of the invention, the protective layer has an elongation at break of ≧100%, preferably of ≧200%. A protective layer of this kind is particularly deformable and in this respect corresponds especially well with the mechanical properties of a polyurethane adhesive layer.

The elongation at break is determined in accordance with DIN EN ISO 527-1.

It is also particularly preferred if the protective layer has a 100% modulus of 0.5 to 20 MPa, preferably of 1 to 15 MPa, more preferably of 2 to 10 MPa. Protective layers of this kind are elastic, resulting in a high overall elasticity of the composite adhesive system, if the adhesive layer as well has corresponding mechanical properties. Particular advantages, therefore, are obtained especially when the composite adhesive system comprises a polyurethane-based adhesive layer.

The 100% modulus is determined in accordance with DIN EN ISO 527-1.

The protective layer may be based more particularly on polymers.

The polymers may preferably be polyurethanes, polyesters, poly(meth)acrylates, polyepoxides, polyvinyl acetates, polyethylenes, polystyrenes, polybutadienes, polyvinyl chlorides and/or corresponding copolymers, preferably polyacrylates and/or polyurethanes.

With particular preference the polymers are polyurethanes which are obtainable by a prepolymerization process in which
a) isocyanate-functional prepolymers are prepared from
   a1) organic polyisocyanates,
   a2) polymeric polyols having number-average molecular weights of 400 to 8000 g/mol, preferably 400 to 6000 g/mol and more preferably of 600 to 3000 g/mol, and OH functionalities of 1.5 to 6, preferably 1.8 to 3, more preferably of 1.9 to 2.1, and
   a3) optionally hydroxyl-functional compounds having molecular weights of 62 to 399 g/mol,
   and
b) the free NCO groups of the prepolymers from a) are then reacted wholly or partly, with chain extension, with
   b1) amino-functional and/or hydroxyl-functional compounds having molecular weights of 32 to 1000 g/mol, preferably of 32 to 400 g/mol.

Suitable polyisocyanates a1) are aliphatic, aromatic or cycloaliphatic polyisocyanates with an NCO functionality of greater than or equal to 2.

Examples of such polyisocyanates are butylene 1,4-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, cyclohexylene 1,4-diisocyanate, 4-isocyanatomethyloctane 1,8-diisocyanate (nonane triisocyanate), phenylene 1,4-diisocyanate, tolylene 2,4- and/or 2,6-diisocyanate, naphthylene 1,5-diisocyanate, 2,2′- and/or 2,4′- and/or 4,4′-diphenylmethane diisocyanate, 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) with C1-C8 alkyl groups.

As well as the abovementioned polyisocyanates it is also possible proportionally to use modified diisocyanates which have a functionality 2, having uretdione, isocyanurate, urethane, allophanate, biuret, iminooxadiazinedione or oxadiazinetrione structure, and also mixtures of these.

The polyisocyanates or polyisocyanate mixtures are preferably those of the aforementioned kind having exclusively aliphatically or cycloaliphatically bonded isocyanate groups, or mixtures of these, and having an average NCO functionality of the mixture of 2 to 4, preferably of 2 to 2.6 and more preferably of 2 to 2.4. In especially preferred embodiments they are difunctional isocyanate building blocks, preferably difunctional aliphatic isocyanate building blocks.

As polyisocyanates a1) it is particularly preferred to use hexamethylene diisocyanate, isophorone diisocyanate or the isomeric bis(4,4′-isocyanatocyclohexyl)methanes, and also mixtures of the aforementioned diisocyanates. In one especially preferred embodiment a mixture of hexamethylene diisocyanate and isophorone diisocyanate is used.

As polymeric polyols a2), compounds are used that have a number-average molecular weight Mₙ of 400 to 8000 g/mol, preferably of 400 to 6000 g/mol and very preferably of 600 to 3000 g/mol. These compounds preferably have an OH functionality of 1.5 to 6, more preferably of 1.8 to 3, very preferably of 1.9 to 2.1.

Suitable polymeric polyols are the polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols that are known per se in polyurethane coatings technology. They may be used individually or in any desired mixtures with one another.

Suitable polyester polyols are polycondensates of di- and also optionally tri- and tetraols and di- and also optionally tri- and tetracarboxylic acids or hydroxycarboxylic acids or lactones. In place of the free polycarboxylic acids it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, and also 1,2-propanediol, 1,3-propanediol, butane-1,3-diol, butane-1,4-diol, hexane-1,6-diol and isomers, neopentylglycol or neopentylglycol hydroxypivalate, with preference being given to hexane-1,6-diol and isomers, butane-1,4-diol, neopentylglycol and neopentylglycol hydroxypivalate. In addition it is also possible to use polyols such as trimethylolpropane, glycerol, erythritol, pentaerythritol, trimethylolbenzene or trishydroxyethyl isocyanurate.

As dicarboxylic acids it is possible to use phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid. The corresponding anhydrides may also be used as an acid source.

Where the average functionality of the polyol to be esterified is >than 2, it is also possible additionally to use monocarboxylic acids as well, such as benzoic acid and hexanecarboxylic acid.

Preferred acids are aliphatic or aromatic acids of the aforementioned kind. Particularly preferred are adipic acid, isophthalic acid and phthalic acid.

Hydroxycarboxylic acids, which may be used additionally as reaction participants in the preparation of a polyester polyol having terminal hydroxyl groups, are, for example, hydroxycaproic acid, hydroxybutyric acid, hydroxydecanoic acid, hydroxystearic acid and the like. Suitable lactones are caprolactone, butyrolactone and homologs. Caprolactone is preferred.

Suitable polycarbonate polyols are hydroxyl-containing polycarbonates, preferably polycarbonate diols, having number-average molecular weights Mₙ of 400 to 8000 g/mol, preferably 600 to 3000 g/mol. They are obtainable by reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentylglycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A and lactone-modified diols of the aforementioned kind.

The diol component preferably contains 40 to 100% by weight of hexanediol, preferably of 1,6-hexanediol and/or hexanediol derivatives. Such hexanediol derivatives are based on hexanediol and in addition to terminal OH groups have ester groups or ether groups. Derivatives of this kind are obtainable by reacting hexanediol with excess caprolactone or by etherifying hexanediol with itself to give the di- or trihexylene glycol.

Instead of or in addition to pure polycarbonate diols it is also possible to use polyether-polycarbonate diols.

Polycarbonates containing hydroxyl groups are preferably of linear construction.

Suitable polyether polyols are, for example, polytetramethylene glycol polyethers, which are obtainable by polymerization of tetrahydrofuran by means of cationic ring opening.

As suitable starter molecules it is possible to use all of the compounds that are known in accordance with the prior art, such as, for example, water, butyldiglycol, glycerol, diethylene glycol, trimethylolpropane, propylene glycol, sorbitol, ethylenediamine, triethanolamine, 1,4-butanediol.

Preferred polyols a2) are polytetramethylene glycol polyethers and polycarbonate polyols, and/or mixtures thereof, with particular preference being given to polytetramethylene glycol polyethers.

As hydroxy-functional compounds a3) it is possible to use polyols of the stated molecular weight range having up to 20 carbon atoms, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentylglycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, trimethylolethane, glycerol, pentaerythritol, and also any desired mixtures thereof with one another.

Also suitable are ester diols from the stated molecular weight range, such as α-hydroxybutyl-ε-hydroxy-caproic ester, ω-hydroxyhexyl-γ-hydroxybutyric ester, β-hydroxyethyl adipate or bis(β-hydroxyethyl) terephthalate.

It is also possible, furthermore, to use monofunctional isocyanate-reactive hydroxyl-containing compounds. Examples of monofunctional compounds of this kind are methanol, ethanol, isopropanol, n-propanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol. If alcohols of this kind react with the isocyanate-functional prepolymer, the fractions correspondingly consumed by reaction are no longer counted as part of the solvents.

As amino-functional compounds b1) it is possible to use organic di- or polyamines such as, for example, 1,2-ethylenediamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentamethylenediamine, diethylenetriamine, 4,4-diaminodicyclohexylmethane, and/or dimethylethylenediamine.

Furthermore, it is also possible to use amino-functional compounds b1) which in addition to a primary amino group also contain secondary amino groups, or in addition to an amino group (primary or secondary) also contain OH groups. Examples of such compounds are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine.

As amino-functional compounds b1), furthermore, it is also possible to use monofunctional isocyanate-reactive amine compounds, such as, for example, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, and/or suitable substituted derivatives thereof, amide amines formed from diprimary amines and monocarboxylic acids, monoketime of diprimary amines, primary/tertiary amines, such as N,N-dimethylaminopropylamine.

Preference is given to using 1,2-ethylenediamine, bis(4-aminocyclohexyl)methane, 1,4-diaminobutane, isophoronediamine, ethanolamine, diethanolamine and diethylenetriamine.

The components a1), a2), a3) and b1) are preferably selected such that no branching site or only a small fraction of branching sites is formed in the polyurethane, since otherwise the result is a high solution viscosity. It is particularly preferred to use exclusively components having an average functionality <2.2, very preferably having an average functionality <2.05. One particularly preferred embodiment uses exclusively difunctional and monofunctional building blocks, and one especially preferred embodiment uses exclusively difunctional building blocks.

In one preferred embodiment the components a1) to a3) and a1) are used for preparing the polyurethane—that is, are incorporated into the polyurethane—in the following amounts, with the individual amounts always adding up to 100% by weight:

5% to 40% by weight of component a1),
55% to 90% by weight of component a2),
0% to 10% by weight of component a3) and
1% to 15% by weight of component b1).

In one particularly preferred embodiment the components a1) to a3) and b1) are used for preparing the polyurethane—that is, are incorporated into the polyurethane—in the following amounts, with the individual amounts always adding up to 100% by weight:

5% to 35% by weight of component a1),
60% to 85% by weight of component a2),
0% to 5% by weight of component a3) and
3% to 10% by weight of component b1).

In one especially preferred embodiment the components a1) to a3) and b1) are used for preparing the polyurethane—that is, are incorporated into the polyurethane—in the following amounts, with the individual amounts always adding up to 100% by weight:

10% to 30% by weight of component a1),

65% to 85% by weight of component a2),
0% to 3% by weight of component a3) and
3% to 8% by weight of component b1).

The amounts listed above for the individual components a1), a2), a3) and b1) denote the amounts used for synthesizing the polyurethane, and take no account of additional quantities of these components which may be present and/or added as solvents.

Before, during or after completely or partially implemented polyaddition of a1), a2) and optionally a3), there may be a dissolution step. A dissolution step may also take place during or after the addition of b1).

It is possible to use mixtures of at least two organic solvents, or only one organic solvent. Mixtures of solvents are preferred.

For the preparation of polyurethane solutions it is preferred to include part or all of components a1), a2) and optionally a3) in the initial charge for preparing an isocyanate-functional polyurethane prepolymer, to carry out dilution, optionally, with a solvent which is inert towards isocyanate groups, and to heat the batch to temperatures in the range from 50 to 120° C. For accelerating the isocyanate addition reaction it is possible to use the catalysts which are known in polyurethane chemistry. Then any constituents, out of a1), a2) and optionally a3) not added at the beginning of the reaction are metered in.

In the preparation of the polyurethane prepolymer a) from a1), a2) and optionally a3), the amount-of-substance ratio of isocyanate groups to isocyanate-reactive groups is generally 1.05 to 3.5, preferably 1.1 to 3.0, more preferably 1.1 to 2.5.

Isocyanate-reactive groups are all groups which are reactive towards isocyanate groups, such as, for example, primary and secondary amino groups, hydroxyl groups or thiol groups.

The reaction of components a1), a2) and optionally a3) to the prepolymer takes place partly or fully, but preferably fully. In this way, polyurethane prepolymers containing free isocyanate groups are obtained in bulk or in solution.

Subsequently, if it has not yet taken place or has taken place only partly, the resulting prepolymer, in a further step in the method, can be dissolved using one or more organic solvents.

In the chain extension in stage b), NH₂- and/or NH-functional components are reacted with the remaining isocyanate groups of the prepolymer.

The degree of chain extension, in other words the equivalents ratio of NCO-reactive groups of the compounds under b), used for chain extension and chain termination, to free NCO groups of the prepolymer prepared under a), is generally between 50% and 150%, preferably between 50% and 120%, more preferably between 60% and 100% and very preferably around 100%.

The aminic components b1) may optionally be used in solvent-diluted form, individually or in mixtures, with in principle any sequence of the addition being possible. Alcoholic solvents as well can be used for chain extension or chain termination. In that case, in general, only a portion of the alcoholic solvents present is incorporated into the polymer chain.

If organic solvents are used as diluents as well, then the diluent content of the component used for chain extension in b) is preferably 1% to 95% by weight, more preferably 3% to 50% by weight, based on the overall weight of component B1) including diluent.

The diluted polyurethane solutions typically contain at least 5% by weight of polyurethane, based on the solids fraction of all of the components present in the composition, i.e. based on the overall solids content. Preferably, however, there is at least 30% by weight, more preferably at least 60% by weight, and very preferably 70% to 99% by weight of polyurethane present, based on the overall solids content.

Suitable solvents for the polyurethane solutions are, esters, such as ethyl acetate or methoxypropyl acetate or butyrolactone, alcohols, such as ethanol, n-propanol or isopropanol, ketones, such as acetone or methyl ethyl ketone, and ethers, such as tetrahydrofuran or tert-butyl methyl ether, for example. It is preferred to use esters, alcohols, ketones and/or ethers. Particular preference is given to the presence of at least one alcohol, preferably at least one aliphatic alcohol, more preferably at least one aliphatic alcohol having 2 to 6 carbon atoms, such as, for example, ethanol, n-propanol and/or isopropanol, and at least one further solvent selected from the groups of the esters, ketones or ethers. The particularly preferred amount of alcoholic solvents is 10% to 80% by weight, very preferably 25% to 65% by weight, based on the total weight of all the solvents. Alcohols in the context of the invention are identified as solvents provided they are added after the isocyanate-functional prepolymer has been formed. The fraction of alcohols used as hydroxy-functional compound a3) during the preparation of the isocyanate-functional prepolymer, and incorporated covalently into said prepolymer, is not counted among the solvents.

Preferably the polyurethane solution contains less than 5% by weight, preferably less than 1% by weight, more preferably less than 0.3% by weight of water, based on the total weight of the solution.

For producing the protective layer it is also possible to use mixtures of different polymers. Suitability is possessed, for example, by mixtures of polymers based on polyurethanes, polyesters, poly(meth)acrylates, polyepoxides, polyvinyl acetates, polyethylene, polystyrene, polybutadienes, polyvinyl chloride and/or corresponding copolymers.

The polymers which can be used for producing the protective layer may also, additionally, comprise auxiliaries and additives. Examples of such auxiliaries and additives are crosslinkers, thickeners, cosolvents, thixotropic agents, stabilizers, antioxidants, light stabilizers, plasticizers, pigments, fillers, hydrophobizing agents and flow control assistants.

The polymers may further comprise biocides, active ingredients which promote wound healing or other active ingredients, such as, for example, analgesics or anti-inflammatories.

The application of the polymers, in the form of a solution, for example, may take place by any of the forms of application known per se—mention may be made, for example, of knife coating, spreading, pouring or spraying. The spraying of a solution of the polymers is preferred.

A multi-layer application, with drying steps in between if desired, is also possible in principle.

After having been dried, the protective layer formed from the polymers may typically have a thickness of 1 to 500 μm, preferably 2 to 300 μm, more preferably 5 to 200 μm, very preferably 5 to 50 μm.

Further subject matter of the invention is a method for producing a composite adhesive system of the invention, wherein
I. an adhesive layer composed of the tissue adhesive is applied to a substrate and
II. the water-impermeable protective layer is applied extensively to the adhesive layer.

Likewise subject matter of the invention is a composite adhesive system obtainable by the method of the invention.

Also subject matter of the invention is a composite adhesive system of the invention for use as a means for covering, sealing or bonding cell tissue.

The use of a composite adhesive system of the invention for producing a means for covering, sealing or bonding cell tissue is also subject matter of the invention.

### EXAMPLES

The invention is elucidated more closely below in detail, using examples.

Unless identified otherwise, all percentages relate to the weight.

Unless noted otherwise, all analytical measurements relate to temperatures of 23° C.

The solids contents were determined in accordance with DIN-EN ISO 3251.

NCO contents, unless expressly noted otherwise, were determined volumetrically in accordance with DIN-EN ISO 11909.

The check for free NCO groups was carried out by means of IR spectroscopy (band at 2260 cm⁻¹).

The reported viscosities were determined by means of rotational viscometry in accordance with DIN 53019 at 23° C. using a rotational viscometer from Anton Paar Germany GmbH, Ostfildern, DE.

### Substances and Abbreviations Used:

Desmophen® C2200: polycarbonate polyol, OH number 56 mg KOH/g, number-average molecular weight 2000 g/mol (Bayer MaterialScience AG, Leverkusen, DE)
Desmophen® C1200: polycarbonate polyol, OH number 112 mg KOH/g, number-average molecular weight 1000 g/mol (Bayer MaterialScience AG, Leverkusen, DE)
PolyTHF® 2000: polytetramethylene glycol polyol, OH number 56 mg KOH/g, number-average molecular weight 2000 g/mol (BASF AG, Ludwigshafen, DE)
PolyTHF® 1000: polytetramethylene glycol polyol, OH number 112 mg KOH/g, number-average molecular weight 1000 g/mol (BASF AG, Ludwigshafen, DE)
Desmophen NH1220 aminic curing agent, equivalent weight 234 (Bayer MaterialScience AG)

### Example 1

### Polymer Layers from Polyurethane Solution (Inventive)

In a standard stirring apparatus, 200 g of PolyTHF® 2000 and 50 g of PolyTHF® 1000 were heated to 80° C. Subsequently at 80° C. over the course of 5 minutes a mixture of 66.72 g of isophorone diisocyanate and 520 g of methyl ethyl ketone was added and the mixture was stirred at reflux until (about 8 hours) the theoretical NCO value had been reached. The finished prepolymer was cooled to 20° C. and then a solution of 25.2 of methylenebis(4-aminocyclohexane) and 519.5 g of isopropanol was metered in over the course of 30 minutes. Stirring then continued until free isocyanate groups were no longer detectable by IR spectroscopy.

The clear solution obtained had the following properties:

Solids content: 25%
Viscosity (viscometer, 23° C.): 4600 mPas

### Example 2

### Polymer Layers from Polyurethane Solution (Inventive)

In a standard stirring apparatus, 200 g of Desmophen C 2200 and 50 g of Desmophen C 1200 were heated to 80° C. Subsequently at 80° C. over the course of 5 minutes a mixture of 66.72 g of isophorone diisocyanate and 520 g of methyl ethyl ketone was added and the mixture was stirred at reflux until (about 8 hours) the theoretical NCO value had been reached. The finished prepolymer was cooled to 20° C. and then a solution of 25.2 of methylenebis(4-aminocyclohexane) and 519.5 g of isopropanol was metered in over the course of 30 minutes. Stirring then continued until free isocyanate groups were no longer detectable by IR spectroscopy.

The clear solution obtained had the following properties:

Solids content: 26%
Viscosity (viscometer, 23° C.): 1800 mPas

### Example 3

### Polymer Layers from Polyurethane Solution (Inventive)

In a standard stirring apparatus, 225 g of PolyTHF® 2000 and 37.5 g of PolyTHF® 1000 were heated to 80° C. Subsequently at 80° C. over the course of 5 minutes a mixture of 50.04 g of isophorone diisocyanate and 485 g of methyl ethyl ketone was added and the mixture was stirred at reflux until (about 16 hours, addition of 2 drops of DBTL after 8 hours) the theoretical NCO value had been reached. The finished prepolymer was cooled to 20° C. and then a solution of 13.70 g of methylenebis(4-aminocyclohexane) and 485 g of isopropanol was metered in over the course of 30 minutes. Stirring then continued until free isocyanate groups were no longer detectable by IR spectroscopy, and then a solids content of approximately 20% by weight was set using a 1:1 mixture of methyl ethyl ketone and isopropanol.

The clear solution obtained had the following properties:

Solids content: 20.8%
Viscosity (viscometer, 23° C.): 11 200 mPas

### Example 4

### Polymer Layers from Polyurethane Solution (Inventive)

In a standard stirring apparatus, 200 g of PolyTHF® 2000 and 50 g of PolyTHF® 1000 were heated to 80° C. Subsequently at 80° C. over the course of 5 minutes a mixture of 66.72 g of isophorone diisocyanate and 500 g of ethyl acetate was added and the mixture was stirred at reflux until (about 8 hours) the theoretical NCO value had been reached. The finished prepolymer was cooled to 20° C. and then a solution of 31.3 g of methylenebis(4-aminocyclohexane) and 500 g of isopropanol was metered in over the course of 30 minutes. Stirring then continued until free isocyanate groups were no longer detectable by IR spectroscopy.

The clear solution obtained had the following properties:

Solids content: 25%
Viscosity (viscometer, 23° C.): 4600 mPas

### Example 5

### Synthesis of a Highly Swelling Polyurethane Wound Adhesive, which was Used for the Subsequent Tests

A 500 ml four-necked flask was charged with 92.6 g of HDI and 0.25 g of dibutyl phosphate. Over the course of 2 hours, at 80° C., 157.1 g of a difunctional polyether having an ethylene oxide content of 71% and a propylene oxide content of 29% (based in each case on the overall alkylene oxide content) were added and stirring was continued for 1 hour. Subsequently the excess HDI was distilled off by thin-film distillation at 130° C. and 0.13 mbar. This gave the prepolymer with an NCO content of 2.42%. The residual monomer content was <0.03% HDI. Viscosity: 2077 mPas.

### Example 6

### Example of an Unprotected Polyurethane Wound Adhesive

Of the prepolymer from Example 5, 4 g, together with 0.53 g of Desmophen NH1220 and 0.47 g of PEG 200, were applied, using a 2-component applicator from Medmix, to a glass plate, in the form of a stripe 3 cm long and 1 cm wide. The plate was placed into warm water at 40° C. for 20 minutes. The adhesive underwent complete detachment.

### Example 7

### Performance Examples for PU Solutions

A stripe 3 cm long and 1 cm wide of the polyurethane wound adhesive from Example 6 was applied to a glass plate with the aid of an applicator. After 30 minutes the polyurethane solutions from Example 1-4 were applied with the aid of a brush in such a way that the wound adhesive and also the surrounding glass plate were completely covered. After a drying time of 5 minutes the plate was inserted into warm water at up to 40° C. for 6 to 40 minutes, and the behavior of the wound adhesive, in terms of swelling and/or detachment from the glass plate, was investigated. Under the polyurethane protective films described, the wound adhesive remained visually unaltered for up to 30 minutes at 40° C. There was no detachment from the glass plate.

### Example 8

### Performance Example for a Polyacrylate System

In the same way as for Example 7, the wound adhesive from Example 6 was oversprayed with an acrylate-based spray plaster, consisting of polyisobutene, isopropyl hydrogenmaleate, methyl acrylate, ethyl acetate and pentane. The protective film protected the underlying adhesive from swelling for up to 40 minutes at 40° C.

1-14. (canceled)

15. A composite adhesive system comprising (1) an adhesive layer comprising a tissue adhesive and a (2) protective layer applied extensively over the adhesive layer, wherein the tissue adhesive is based on hydrophilic polyurethane polymers, and wherein the protective layer is water-impermeable, wherein the tissue adhesive comprises
A) an isocyanate-functional prepolymer obtained from
A1) aliphatic isocyanates and
A2) polyols having number-average molecular weights of ≧400 g/mol and average OH functionalities of from 2 to 6,
B) amino-functional aspartic esters of the general formula (I) 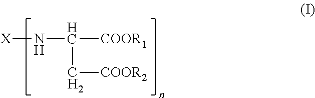
wherein
X is an n-valent organic radical obtained by removing a primary amino group of an n-valent amine,
R₁ and R₂ are identical or different organic radicals which contain no Zerewitinoff-active hydrogen, and
n is an integer of at least 2,
and/or
C) reaction products of isocyanate-functional prepolymers A) with aspartic esters B).

16. The composite adhesive system of claim 15, wherein the isocyanates A1) contain exclusively aliphatically or cycloaliphatically bonded isocyanate group.

17. The composite adhesive system of claim 15, wherein the polyols A2) are polyalkylene oxide polyethers comprising an ethylene oxide-based unit content of from 60% to 90% by weight, based on the amounts of alkylene oxide units present overall.

18. The composite adhesive system of claim 15, wherein the aspartic esters B) are compounds of the formula (I) in which
X is derived from 4-diaminobutane, 1,5-diaminopentane, 2-methyl-1,5-diaminopentane, 1,6-diamino-hexane, 2,2,4- or 2,4,4-trimethyl-1,6-diamino-hexane as n-valent amines,
R₁ and R₂ are, each independently of one another, a C₁ to C₁₀-alkyl radical, and
n is 2.

19. The composite adhesive system of claim 15, wherein the tissue adhesive comprises no aspartic ester B) but instead exclusively reaction products C).

20. The composite adhesive system of claim 15, wherein the protective layer has an elongation at break of ≧100%

21. The composite adhesive system of claim 15, wherein the protective layer has a 100% modulus of from 0.5 to 20 MPa.

22. The composite adhesive system of claim 15, wherein the protective layer is based on polymers.

23. The composite adhesive system of claim 22, wherein the polymers are polyurethanes, polyesters, poly(meth)acrylates, polyepoxides, polyvinyl acetates, polyethylenes, polystyrenes, polybutadienes, polyvinyl chlorides and/or corresponding copolymers, preferably polyacrylates and/or polyurethanes.

24. The composite adhesive system of claim 15, wherein the polymers are polyurethanes obtained by a prepolymerization process wherein
a) isocyanate-functional prepolymers are prepared from
a1) organic polyisocyanates,
a2) polymeric polyols having number-average molecular weights of from 400 to 8000 g/mol, and OH functionalities of from 1.5 to 6, and
a3) optionally hydroxyl-functional compounds having molecular weights of from 62 to 399 g/mol,
and
b) the free NCO groups of the prepolymers from a) are then reacted wholly or partly, with chain extension, with
b1) amino-functional and/or hydroxy-functional compounds having molecular weights of from 32 to 1000 g/mol.

25. A method for producing the composite adhesive system of claim 15, comprising the steps of (1) applying an adhesive layer composed of the tissue adhesive to a substrate and (2) applying the water-impermeable protective layer extensively to the adhesive layer.

26. The composite adhesive system prepared by the method of claim 25.

27. The composite adhesive system of claim 20, wherein the protective layer has an elongation at break of ≧200%.

28. The composite adhesive system of claim 21, wherein the protective layer has a 100% modulus of from 1 to 15 MPa.

29. The composite adhesive system of claim 28, wherein the protective layer has a 100% modulus of from 2 to 10 MPa.

30. The composite adhesive system of claim 24, wherein the polymeric polyols a2) have number-average molecular weights of from 400 to 6000 g/mol, and OH functionalities of from 1.8 to 3.

31. The composite adhesive system of claim 30, wherein the polymeric polyols a2) have number-average molecular weights of from 600 to 3000 g/mol, and OH functionalities of from 1.9 to 2.1.

32. The composite adhesive system of claim 24, wherein the amino-functional and/or hydroxy-functional compounds b1) have molecular weights of from 32 to 400 g/mol.
